(19) United States
(12) Patent Application Publication
(10) Pub. No.: US 2017/0029642 A1
(43) Pub. Date: Feb. 2, 2017

(54) AQUEOUS INK FOR INKJETTING

(71) Applicant: CANON KABUSHIKI KAISHA, Tokyo (JP)

(72) Inventors: Taketoshi Okubo, Asaka-shi (JP); Kenichi Iida, Kawasaki-shi (JP)

(21) Appl. No.: 15/301,768

(22) PCT Filed: Jun. 4, 2015
(86) PCT No.: PCT/JP2015/066800

§ 371 Date: Oct. 4, 2016

(30) Foreign Application Priority Data
Jun. 16, 2014 (JP) 2014-123263
May 25, 2015 (JP) 2015-105908

(51) Int. Cl. C09D 11/322; C09D 11/328

(52) U.S. Cl. CPC C09D 11/322; C09D 11/328

(57) ABSTRACT

An aqueous ink for inkjetting, capable of recording an image exhibiting a natural metallic color with reduced diffused light having a color hue different from the desired metallic color by an inkjetting method, is provided.

The aqueous ink for inkjetting includes organic colorant particles made of an organic colorant giving a metallic color, and a black color dye. Alternatively the aqueous ink for inkjetting includes metal particles giving a metallic color on a recording medium, and a black color dye.

### TECHNICAL FIELD

The present invention relates to an aqueous ink for inkjetting.

### BACKGROUND ART

In conventional recorded materials such as printed advertisement materials and photographs, inks using a metal pigment such as an aluminum pigment and a pearl pigment have been used for recording an image having a metallic color (metallic luster color) by offset printing, gravure printing, screen printing, or the like. Due to recent progress in inkjet recording, an aqueous ink capable of recording an image having a metallic luster color by inkjet recording is required.

Inks containing metal particles have been proposed as inks for recording an image having a metallic luster color by inkjet recording (Patent Literature 1 and 2). In order to present an image having a colored part exhibiting a metallic color, organic colorants giving a metallic color are under examination (Patent Literature 3 and 4).

### CITATION LIST

### Patent Literature

PTL 1: Japanese Patent Application Laid-Open No. 2011-241242
PTL 2: Japanese Patent Application Laid-Open No. 2004-059805
PTL 3: Japanese Patent Application Laid-Open No. 2000-256357
PTL 4: Japanese Patent Application Laid-Open No. 2006-249259

### SUMMARY OF INVENTION

### Technical Problem

Accordingly, the present inventors prepared an ink containing organic colorant or metal particles giving a metallic color and provided the ink to a recording medium so as to form an image. The image, however, had an unsatisfactory metallic texture, having not achieved a desired metallic image. An object of the present invention is therefore to provide an aqueous ink for inkjetting from which a metallic image having a satisfactory metallic texture can be produced.

### Solution to Problem

The object described above can be achieved by the present invention described in the following. In other words, the present invention provides an aqueous ink for inkjetting containing organic colorant particles made of an organic colorant or metal particles giving a metallic color, and a black color dye.

### Advantageous Effects of Invention

The present invention can provide an aqueous ink for inkjetting capable of producing a metallic image having satisfactory metallic texture.

Further features of the present invention will become apparent from the following description of exemplary embodiments.

### DESCRIPTION OF EMBODIMENTS

The present invention is described in detail in the following with reference to preferred embodiments.

In the first place, the present inventors examined the reason why a satisfactory metallic texture cannot be obtained only by providing an ink which contains organic colorant particles giving a metallic color or an ink which contains metal particles (hereinafter also simply referred to as “metallic ink” or “ink”) to a recording medium. As a result, the cause was found to be “turbidity” of the metallic color due to diffused light reflected on an image at a reflection angle different from that of the specular reflection light (reflection light which reflects in the mirror surface direction at a reflection angle which is the same as the incidence angle of incident light), having a color hue different from a metallic color, though the specular reflection light gives a metallic color. Based on the finding, the present inventors presumed that the desired metallic texture can be obtained by reducing the diffused light, and the constitution of the present invention was accomplished through precise examination.

Namely, the present invention relates to an aqueous ink for inkjetting which contains organic colorant or metal particles giving a metallic color, and black color dye. A metallic image having a highly metallic texture can be formed by inkjet recording with the ink of the present invention.

The reason for achievement of the highly metallic texture due to the presence of a black color dye in the ink of the present invention is presumed as follows. When the ink of the present invention is discharged from an inkjet head, the organic colorant particles or metal particles are stacked on a recording medium so as to form a “coloring material layer”, while the black color dye infiltrate into the recording medium so as to form a black-colored “foundation”. The “foundation” reduces the diffused light having a color hue different from the metallic color from the “coloring material layer”. A metallic image having a desired highly metallic texture having a color of gold, copper, or the like can be thereby produced. Each of the materials for use in the aqueous ink for inkjetting of the present invention is described in the following.

(Organic Colorant Particles)

In the present invention, the ink contains organic colorant particles giving a metallic color on a recording medium. In the present invention, a “metallic color” means a metal color having a metallic luster such as gold color, a silver color, and a copper color. In the present invention, an “organic colorant” means an organic compound which imparts a color to an object by absorption or emission of visible light. Examples of the organic colorant giving a metallic color include an azamethine-based colorant (e.g. colorants described in International Publication No. WO2014/034093 and International Publication No. WO2014/034094), a pyrrole-based colorant (e.g. a colorant described in Patent Literature 3), an aniline-based colorant (e.g. a colorant described in Patent Literature 4), a cyanine-based colorant, a melocyanine-based colorant, a xanthenes-based colorant, an azo-based colorant, a quinacridone-based colorant, triphenylmethane-based colorant, and a phthalocyanine-based colorant. The organic colorants giving a metallic color may be used singly or in combination of two or more.

Whether an organic colorant gives a metallic color or not can be determined by the following procedure. In the first place, a film of an organic colorant is formed on a recording medium having a smooth surface (e.g. a recording medium such as a quartz glass wafer having an arithmetic average roughness Ra of 0.001 μm or less). Examples of the method for forming the film include a dipping method, a spin coating method, a bar coating method, and a vapor deposition method. Subsequently, the angular dependence of brightness L* which represents the brightness of the formed film is measured with a variable angle spectrophotometer (e.g. GSP-2 (made by Murakami Research Laboratory)), so that an organic colorant having a sharpness value, which is represented by an expression (A): sharpness value=L/w, of 0.2 or more can be determined as an “organic colorant giving a metallic color”. In the expression, L represents a value of the highest brightness among the brightness L* measured at the light receiving part of the variable angle spectrophotometer, and w represents the width of the light receiving angle of two points having the half value of L (1/2). With a sharpness value of 0.2 or more, the brightness varies depending on the view angle so that a metallic color can be visually recognized. In order to give a better metallic color, the sharpness value is preferably 0.4 or more, more preferably 1.0 or more.

The content (mass %) of the organic colorant particles in an ink is preferably 0.5 mass % or more and 10 mass % or less, more preferably 1 mass % or more and 8 mass % or less, most preferably 2 mass % or more and 6 mass % or less, relative to the total mass of the ink. With a content of the organic colorant particles of 0.5 mass % or more, an image having sufficient metallic luster can be recorded. Further, with a content of the organic colorant particles of 10 mass % or less, the discharge stability of the ink can be secured.

The volume average particle diameter of the organic colorant particles is preferably 5 nm or more and 500 nm or less, more preferably 10 nm or more and 200 nm or less. The organic colorant particles having a volume average particle diameter of 5 nm or more tend to remain on a recording medium so that an image exhibiting a more satisfactory metallic color can be recorded. Further, using the organic colorant particles having a volume average particle diameter of 500 nm or less, the discharge properties of the ink from a recording head for inkjetting can be improved. Further, the volume average particle diameter of organic colorant particles in a liquid can be measured with use of, for example, a particle size distribution measurement apparatus of dynamic light scattering type. Examples of the particle size distribution measurement apparatus of dynamic light scattering type for use include “FPAR-1000” (trade name, made by Otsuka Electronics Co., Ltd., cumulant analysis method) and “UPA-EX150 (trade name, made by Nikkiso Co., Ltd.).

The organic colorant is dispersed in an ink so as to form a dispersion of organic colorant particles. Examples of the dispersion of organic colorant particles include: (i) a dispersion using a resin dispersant; (ii) a dispersion using a low-molecular weight dispersant; (iii) a self dispersion capable of holding a dispersing state without a dispersant. In the present invention, any one of the dispersions may be employed.

In the case of a dispersion using “(i) a resin dispersant”, the content of the resin dispersant in an ink is preferably 10 parts by mass or more and 400 parts by mass or less relative to 100 parts by mass of organic colorant particles. The content is more preferably 20 parts by mass or more and 300 parts by mass or less, particularly preferably 30 parts by mass or more and 200 parts by mass or less. With a content of the resin dispersant of 10 parts by mass or more relative to 100 parts by mass of organic colorant particles, the dispersion stability can be improved. On the other hand, with a content of the resin dispersant of 400 parts by mass or less relative to 100 parts by mass of organic colorant particles, an image exhibiting a better metallic color can be recorded.

A preferred resin dispersant is capable of stably dispersing organic colorant particles in an aqueous medium due to effects of an anionic group. Specific examples of the resin dispersant include a styrene-acrylic acid copolymer, a styrene-acrylic acid-alkyl acrylate copolymer, a styrene-maleic acid copolymer, a styrene-maleic acid-alkyl acrylate copolymer, a styrene-methacrylic acid copolymer, a styrene-methacrylic acid-alkyl acrylate copolymer, a styrene-maleic acid half ester copolymer, a vinylnaphthalene-acrylic acid copolymer, a vinylnaphthalene-maleic acid copolymer, a styrene-maleic anhydride-maleic acid half ester copolymer, and a salt thereof.

The weight average molecular weight of the resin dispersant is preferably 2,000 or more and 50,000 or less, more preferably 3,000 or more and 25,000 or less, particularly preferably 5,000 or more and 15,000 or less. Use of the resin dispersant having a weight average molecular weight in the range can improve the dispersion stability. The acid value of the resin dispersant is preferably 80 mg KOH/g or more and 250 mg KOH/g or less, more preferably 100 mg KOH/g or more and 200 mg KOH/g or less. Use of the resin dispersant having an acid value of 80 mg KOH/g or more can improve the discharge properties of an ink from a recording head for inkjetting. Further, the resin dispersant having an acid value of 250 mg KOH/g or less easily adsorbs organic colorant particles, so that the dispersion stability of organic colorant particles can be improved.

An acrylic resin based dispersant is preferred as the resin dispersant. A styrene-acrylic acid copolymer is further preferred among the acrylic resin based dispersants. The acrylic resin based dispersant may be prepared by a conventionally known polymerization method or may be a commercial product.

Specific examples of the commercial product of acrylic resin based dispersant include JONCRYL (registered trade mark) series (trade name, made by BASF Japan Ltd.). More specific examples include the following products by trade name: JONCRYL 67 (weight average molecular weight: 12,500; acid value: 213 mg KOH/g), JONCRYL 678 (weight average molecular weight: 8,500; acid value: 215 mg KOH/g), JONCRYL 586 (weight average molecular weight: 4,600; acid value: 108 mg KOH/g), JONCRYL 680 (weight average molecular weight: 4,900; acid value: 215 mg KOH/g), JONCRYL 682 (weight average molecular weight: 1,700; acid value: 238 mg KOH/g), JONCRYL 683 (weight average molecular weight: 8,000; acid value: 160 mg KOH/g), JONCRYL 690 (weight average molecular weight: 16,500; acid value: 240 mg KOH/g), JONCRYL 819 (weight average molecular weight: 14,500; acid value: 75 mg KOH/g), JONCRYL JDX-C3000 (weight average molecular weight: 10,000; acid value: 85 mg KOH/g), and JONCRYL JDX-C3080 (weight average molecular weight: 14,000; acid value: 230 mg KOH/g).

The acrylic resin based dispersant in the JONCRYL series is a copolymer of (meth)acrylic acid and at least any one of alkyl (meth)acrylate and a styrene based monomer. For example, “JONCRYL JDX-C3000” is a copolymer of (meth)acrylic acid and alkyl (meth)acrylate. Incidentally, all of the weight average molecular weight and the acid value of the acrylic resin based dispersant in JONCRYL series are based on catalog values.

In order to dissolve the resin dispersant in water, an acid group (e.g. carboxy group) in the resin dispersant can form a salt with a counter cation. Examples of the counter cation include: an ion formed from an inorganic base such as a lithium ion, a potassium ion, a sodium ion, a calcium ion, a cesium ion, and ammonium ion; and an ion formed from an organic base (amines) such as aminomethyl propanol, 2-aminoisopropanol, triethanolamine, and morpholine. The content of the base can correspond to a neutralization equivalent to the resin dispersant or more, from the viewpoint of dispersion stability.

In order to achieve easy ionic dissolution of the salt of a resin dispersant, a pH modifier may be contained in the ink. A pH modifier capable of adjusting the pH of an ink to 6 or more and 11 or less may be used. Specific examples of the pH modifier include potassium hydrogen phthalate, potassium dihydrogen phosphate, disodium hydrogen phosphate, sodium tetraborate, potassium hydrogen tartrate, sodium hydrogen carbonate, sodium carbonate, tris(hydroxymethyl)aminomethane, and tris(hydroxymethyl)aminomethane hydrochloride.

The “(ii) low-molecular weight dispersant” is a kind of surfactants having a hydrophilic portion and a hydrophobic portion with a molecular weight less than 1,000, and a component which reduces the interfacial tension between a hydrophobic pigment surface and an aqueous medium so as to achieve dispersion of the pigment in an ink. Examples of the hydrophilic portion include an anionic group, a cationic group, a nonionic group, and a betaine-type having an anionic group and a cationic group. The anionic group is a group to be negatively charged. Examples of the anionic group include a carboxy group, a sulfonic acid group, a sulfuric acid group, a phosphonic acid group, and a phosphoric acid group. The cationic group is a group to be positively charged. Examples of the cationic group include an ammonium group and a pyridinium group. Examples of the nonionic group include a polyethylene oxide group and a saccharide unit. The hydrophilic portion is preferably an anionic group, more preferably a sulfonic acid group or a carboxy group.

Examples of the hydrophobic portion include a hydrocarbon, a fluorocarbon and silicone. The hydrophobic portion is preferably a hydrocarbon, more preferably a hydrocarbon having 2 to 24 carbon atoms, particularly preferably a hydrocarbon having 6 to 20 carbon atoms. The hydrophobic portion may be linear or a branched and may be a single chain or a plurality of chains.

Examples of the anionic dispersant (anionic surfactant) having an anionic group include an N-acyl-N-methyltaurine salt, a fatty acid salt, an alkyl sulfate salt, an alkylbenzene sulfonate salt, an alkylnaphthalene sulfonate salt, a dialkyl sulfosuccinate salt, an alkyl phosphate salt, a naphthalene sulfonate formalin condensate, and a polyoxyethylene alkyl sulfate salt. An alkaline metal cation can be a cation forming the salt. The anionic dispersants may be used singly or in combination of two or more.

Examples of the cationic dispersant (cationic surfactant) having a cationic group include a quaternary ammonium salt, an alkoxylated polyamine, an aliphatic amine polyglycol ether, an aliphatic amine, a diamine and a polyamine which are derived from an aliphatic amine and an aliphatic alcohol, imidazoline derived from fatty acid, and a salt thereof.

An amphionic dispersant (amphionic surfactant) is a dispersant having in a molecule both of the following groups: an anionic group which an anionic dispersant has in a molecule and a cationic group which a cationic dispersant has in a molecule.

Examples of the nonionic dispersant (nonionic surfactant) include a polyoxyethylene alkyl ether, a polyoxyethylene alkylaryl ether, a polyoxyethylene fatty acid ester, a sorbitan fatty acid ester, a polyoxyethylene sorbitan fatty acid ester, a polyoxyethylene alkylamine, and a glycerol fatty acid ester. Among them, a polyoxyethylene alkylaryl ether is preferred. The nonionic dispersants may be used singly or in combination of two or more.

The “(iii) self dispersion” contains a self dispersion type pigment including a hydrophilic functional group introduced directly to the surface or through another atomic group to the surface of pigment so as to achieve dispersion in an aqueous medium substantially without use of a dispersant. Examples of the hydrophilic functional group include a sulfonic acid group, a carboxy group, and a phosphonic acid group.

(Metal Particles)

In another embodiment, the ink of the present invention contains metal particles which give a metallic color on a recording medium. The “metal particles” are particles containing one or a plurality of metal materials, and the kind of the metal material is not specifically limited as long as the particles give a metallic color on a recording medium. The metal material to constitute the metal particles is preferably gold, silver, or copper, more preferably silver. The metal particles may be prepared by any method. For example, the metal particles can be suitably formed by preparing a solution which contains a metal ion and reducing the metal ion. Further, in order to form an aqueous dispersion of the metal particles, the various dispersants described above may be appropriately used.

The diameter of the metal particles is preferably 3 nm or more, more preferably 10 nm or more. With a diameter of the metal particles less than 3 nm, a metallic color may not be given on a recording medium in some cases. The diameter of the metal particles is preferably 130 nm or less, more preferably 100 nm or less. With a diameter of the metal particles more than 130 nm, the dispersion stability of the metal particles in an ink may deteriorate in some cases. Incidentally the average particle diameter (D50) of metal particles in liquid may be measured with, for example, a particle size distribution measuring apparatus of dynamic light scattering type. Examples of the particle size distribution measuring apparatus of dynamic light scattering type for use include “FPAR-1000” (trade name, made by Otsuka Electronics Co., Ltd., cumulant analysis method), “UPA-EX150 (trade name, made by Nikkiso Co., Ltd.), and “LB-550” (trade name, made by Horiba Ltd.). Incidentally, the particle diameter in the specification means the “volume average particle diameter” measured by the measuring method described above.

(Black Color Dye)

The ink of the present invention contains a black color dye. The black color dye means a water-soluble color material which for forming a black image on a recording medium, of which the solution absorbs transmitting light in the whole wavelength range of visible light (380 nm to 780 nm). The black color dye may be a dye which alone gives a black color or may be a mixture of a combination of a plurality of dyes other than a black color dye (e.g. a cyan dye, a magenta dye, and a yellow dye). Specific examples of the black color dye include: C. I. Direct blacks 19, 22, 32, 38, 51, 56, 71, 74, 75, 77, 154, 168 and 171; and other known dyes which give a black color. The dyes may be used singly or as a mixture of two or more. Alternatively the dyes other than a black color dye may be used in an appropriate combination. Further, a commercially available black color dye ink for inkjetting may be used.

The black color dye can be a dye of which the aqueous solution exhibits absorption with a molar extinction coefficient of 5000 L/mol·cm or more in the whole wavelength range of 450 nm to 650 nm. The molar extinction coefficient can be measured with an absorption spectrophotometer (e.g. UV-3600 (made by Shimadzu Corporation)).

The ink of the present invention contains the black color dye, absorbing the light transmitting through the ink in the whole wavelength range of 450 nm to 650 nm. In order to sufficiently reducing the diffused light, the ink of the present invention diluted 1000 times can have a transmittance of 65% or less in the wavelength range (450 to 650 nm) measured with an absorption spectrophotometer with an optical path length of 10 mm. The presence of a region having a transmittance more than 65% causes the formed film to have insufficient reduction in diffused light having a color different from the metallic color given by an organic colorant, resulting in turbidity in color in some cases.

The diffused light from a solid image sample of 100% duty recorded on a recording medium, with use of an ink which contains the black color dye of the present invention, has a brightness L* of preferably 35 or less, more preferably 25 or less, particularly preferably 15 or less, in the CIE L*a*b* color system. The brightness value L* can be obtained by colorimetry excluding the specular component with an integrating sphere type spectrophotometer under a D50 light source environment. (Based on the measurement principle established in the international standard ISO 7724/1, the colorimetry is performed in accordance with the method described in the condition c in JIS Z 8722. The colorimetry is also in accordance with the method for measuring an object color defined by International Commission on Illumination (CIE) No. 15, and ASTM E1164 specified by American Society of Testing Materials.) More specifically, the brightness value L* can be measured with a specular component excluded (SCE) mode of a spectrophotometer (e.g. trade name: CM-2600d, made by Konica Minolta, Inc.). In the present invention, a D50 light source (specified in JIS Z 8720: 2012) suitable for colorimetry of a printed matter can be used as the light source environment condition for colorimetry with a specular component excluded mode of an integrating sphere type spectrophotometer. The light source for use in colorimetry is not limited to a D50 light source, and an A light source, a C light source, or a D65 light source (specified in JIS Z 8720: 2012) may be used. Further, light sources other than these such as an F2 light source, an F6 light source, an F7 light source, an F8 light source, an F10 light source, and F12 light source may be used. A suitable light source for use may be appropriately selected depending on the recording conditions and the environment.

In the present invention, the foundation layer to be formed with the black dye on a recording medium has a thickness (layer thickness) of, preferably 0.001 μm or more, more preferably 0.01 μm or more, furthermore preferably 0.05 μm or more. And the layer thickness is preferably 10 μm or less, more preferably 5 μm or less, and furthermore preferably 1 μm or less. The method for measuring the layer thickness is not specifically limited, as long as the layer thickness in a μm order can be measured. The layer thickness may be measured by, for example, observing the cut cross-section of an image with a scanning electron microscope.

The total content (mass %) of the black color dyes is preferably 1 mass % or more and 10 mass % or less, more preferably 2 mass % or more and 8 mass % or less, particularly preferably 3 mass % or more and 8 mass % or less, relative to the total mass of the ink. With a content of the dye less than 1 mass %, the diffused light having a color hue different from the metallic color is not sufficiently reduced in some cases. On the other hand, with a content of the dye more than 10 mass %, the discharging properties of the ink is lowered in some cases.

The mass ratio of the black color dye to the organic colorant particles in an ink (black color dye/organic colorant particles) is preferably 1/10 or more and 10/1 or less, more preferably 1/5 or more and 5/1 or less. With a mass ratio of the black color dye to the organic colorant particles in an ink out of the range, the metallic texture is weakened in some cases.

(Ink Medium)

The ink of the present invention contains an aqueous medium formed of a mixture solvent of water and a water-soluble organic solvent. The water for use can be a deionized water. The water content (mass %) in the ink relative to the total mass of the ink is preferably 30 mass % or more, more preferably 40 mass % or more, particularly preferably 50 mass % or more. And the water content (mass %) in the ink relative to the total mass of the ink is preferably 95 mass % or less, and more preferably 90 mass % or less. With a water content of 30 mass % or more, the viscosity of the ink decreases, achieving improved stability of continuous discharging. With a water content of 95 mass % or less, adherence inside the nozzle of a recording head for inkjetting is hardly caused. Any water-soluble organic solvent which can be used for inks for inkjetting such as alcohols, glycols, glycol ethers, and nitrogen-containing compounds may be contained singly or in combination of two or more in an ink. The water-soluble organic solvent can have a vapor pressure at 25° C. lower than that of water. Among the solvents, polyalcohols such as glycerol and trimethylolpropane, glycols such as triethylene glycol, and nitrogen-containing compounds such as 2-pyrolidone are particularly preferred for use. Further, water-soluble organic compounds in a solid form at normal temperature such as urea and derivatives thereof, trimethylolpropane, and trimethylolethane are dissolved in water to make a liquid as solvent for dispersing pigments, which can be treated like a water-soluble organic solvent.

Any known water-soluble organic solvent for general use in the inks for inkjetting can be used. Specific examples of the water-soluble organic solvent include mono- or polyalcohols, alkylene glycols of which the alkylene group has about 1 to 4 carbon atoms, polyethylene glycols having a number average molecular weight of 200 or more and 2,000 or less, glycol ethers, and nitrogen-containing compounds. The water-soluble organic solvents may be used singly or in combination of two or more. The content (mass %) of the water-soluble organic solvent in an ink is preferably 1 mass % or more and 40 mass % or less, more preferably 3 mass % or more and 30 mass % or less, relative to the total mass of the ink.

(Surfactant)

The ink of the present invention can contain a surfactant. Any conventionally known surfactant may be used as the surfactant. Among them, a nonionic surfactant is preferred for use. Among the nonionic surfactants, an ethylene oxide adduct such as polyoxyethylene alkyl ether and acetylene glycol is preferred for use. The content (mass %) of the surfactant in an ink is preferably 0.1 mass % or more and 5 mass % or less, more preferably 0.2 mass % or more and 4 mass % or less, particularly preferably 0.3 mass % or more and 3 mass % or less, relative to the total mass of the ink.

(Other Components)

The ink of the present invention may contain various additives such as a defoaming agent, a rust inhibitor, an antiseptic, an anti-mold agent, an antioxidant, an anti-reduction agent, an evaporation accelerator, and a chelating agent besides the components described above on an as needed basis.

(Physical Properties of Ink)

In the case that the ink of the present invention contains a resin dispersant, the pH of the ink can be the isoelectric point or more of the resin dispersant from the viewpoint of storage stability. From the viewpoint of maintaining a stable dispersion state of the organic colorant particles in the ink, the pH of the ink can be 6 or more.

From the viewpoint of securing the discharge properties from a recording head, the surface tension of the ink is preferably 20 mN/m or more and 40 mN/m or less, more preferably 25 mN/m or more and 40 mN/m or less. Further, the viscosity of the ink is preferably 15 mPa·s or less, more preferably 10 mPa·s or less, particularly preferably 5 mPa·s or less.

<Inkjet Recording Apparatus and Inkjet Recording Method>

The inkjet recording apparatus is an apparatus for recording an image on a recording medium by discharging the ink of the present invention described above from a recording head in an inkjetting method. The inkjet recording method is a method for recording an image on a recording medium by discharging the ink of the present invention described above from the recording head in an inkjetting method. Examples of the method for discharging ink include a method for imparting dynamic energy to an ink and a method for imparting thermal energy to an ink. A conventionally known structure or process may be employed as the structure of the inkjet recording apparatus or the process of the inkjet recording method, except that the ink of the present invention is used.

The layer thickness of a coating film to be formed by providing the ink of the present invention which contains organic colorant particles onto a recording medium is preferably 0.01 μm or more, more preferably 0.03 μm or more, furthermore preferably 0.05 μm or more. And the layer thickness is preferably 100 μm or less, more preferably 10 μm or less, furthermore preferably 1 μm or less.

The layer thickness of a coating film to be formed by providing the ink of the present invention which contains metal particles onto a recording medium is preferably 0.003 μm or more, more preferably 0.01 μm or more, furthermore preferably 0.05 μm or more. With a layer thickness of the ink which contains the metal particles of 0.003 μm or more, the coating film can give an excellent metallic color. And the layer thickness of the ink which contains the metal particles for giving a metallic color on a recording medium is preferably 100 μm or less, more preferably 10 μm or less, furthermore preferably 1 μm or less. With a layer thickness of the coating film having a metallic color of 100 μm or less, no difference in the level occurs between regions with and without the ink of the present invention, so that an excellent quality image can be produced.

The film thickness of the coating film having a metallic color can be measured as follows, though not specifically limited. Examples of the measurement method include: measuring the difference in level between the surface of a recording medium exposed by peeling a part of the coating film having a metallic color with an adhesive tape or the like and the coating film having a metallic color, with use of a noncontact level difference meter or a confocal laser scanning microscope; and measuring the cross-section of the ink layer as coating film obtained by cutting the printed part including the recording medium with a razor blade or the like, using the length measuring function of a scanning electron microscope (SEM).

(Recording Medium)

A recording medium which allows the black color dye in an ink to infiltrate into the recording medium and allows the organic colorant particles and metal particles to be stacked on the surface or the vicinity of the surface of the recording medium can be used. Specific examples of the recording medium include a commercially available printer paper for inkjetting, a resin film such as an OHP sheet, cloth and metal. Among them, a printer paper for inkjetting having an ink receiving layer which allows the black color dye to rapidly infiltrate therein and prevents the organic colorant particles from infiltrating therein can be used as a recording medium.

### EXAMPLES

The present invention is further described in detail in the following with reference to Examples and Comparative Examples, though the present invention is not limited to the following Examples, as long as modifications are made within the scope of the invention. Incidentally, the “parts” and “%” in description of the amount of components are represented in mass basis unless otherwise specified. The volume average particle diameter of the organic colorant particles was measured with a particle size distribution measurement apparatus of dynamic light scattering type (trade name: UPA-EX150, made by Nikkiso Co., Ltd.), unless otherwise specified.

[Water Dispersion 1]

An aniline-based colorant 2,2′-[1,4-phenylenebis[methylene(phenylimino)-4,1-phenylene]]bis-ethylenetricarbonitrile (organic colorant 1) was obtained with reference to the synthesis method described in Patent Literature 4. 3 parts of the organic colorant 1 were dissolved in 200 parts of chloroform to obtain a mixture liquid. On the other hand, a KOH aqueous solution was added to a mixture of 5 parts of a polymer dispersant (styrene-acrylic acid copolymer, weight average molecular weight: 12,000, acid value: 170 mg KOH/g) and 500 parts of water to adjust to pH 10 so as to obtain an aqueous solution of a polymer dispersant. The mixture liquid of the organic colorant 1 and chloroform was added to the aqueous solution of the polymer dispersant, and the mixture was then subjected to emulsification for 15 minutes under ice cooling with an ultrasonic homogenizer so as to obtain an emulsion. Chloroform was distilled away from the produced emulsion under reduced pressure with an evaporator so that a water dispersion 1 of the organic colorant 1 was obtained. The organic colorant particles in the produced water dispersion had a volume average particle diameter of 88 nm.

[Water Dispersion 2]

A water dispersion 2 of the organic colorant 1 was obtained by the same way as in the preparation method of the water dispersion 1, except that 1.5 parts of sodium dodecyl sulfate (SDS) was used as dispersant. The organic colorant particles in the produced water dispersion had a volume average particle diameter of 34 nm.

[Water Dispersion 3]

A pyrrole-based colorant 2-[5-[1-(4-methylphenyl)-5-(2-thienyl)-1H-pyrrole-2-yl]-2-thienyl]-1,1,2-ethylenetricarbonitrile (organic colorant 2) was obtained with reference to the synthesis method described in Patent Literature 3. A water dispersion 3 of the organic colorant 2 was obtained by the same way as in the preparation method of the water dispersion 1. The organic colorant particles in the produced water dispersion had a volume average particle diameter of 28 nm.

[Water Dispersion 4]

An azamethine-based colorant (Z)—N-(3-cyano-5-((2-(dibutylamino)-4-phenylthiazol-5-yl)methylene)-2,6-dioxo-4-phenyl-5,6-dihydropyridine-1(2H)-yl)benzamide (organic colorant 3) was obtained with reference to the synthesis method described in International Publication No. WO2014/034093. A water dispersion 4 of the organic colorant 3 was obtained by the same way as in the preparation method of the water dispersion 2. The organic colorant particles in the produced water dispersion had a volume average particle diameter of 70 nm.

[Water Dispersion 5]

A phthalocyanine-based colorant as self dispersion pigment CAB-O-JET450C (made by Cabot Corporation, pigment species: PB15:4) was purchased to obtain a water dispersion 5. The organic colorant particles in the water dispersion had a volume average particle diameter of 72 nm.

[Water Dispersion 6]

An azo-based colorant as self dispersion pigment CAB-O-JET470Y (made by Cabot Corporation, pigment species: PY74) was purchased to obtain a water dispersion 6. The organic colorant particles in the water dispersion had a volume average particle diameter of 116 nm.

[Water Dispersion 7]

A silver nano-colloid H-1 (made by Mitsubishi Materials Electronic Chemicals Co., Ltd.) was purchased to obtain a water dispersion 7. The silver particles in the water dispersion had a volume average particle diameter of 32 nm (measured with a particle size distribution measuring apparatus of dynamic light scattering type LB-550 (made by Horiba Ltd.)).

[Water Dispersion 8]

A gold nano-colloid solution AuPVP (made by Tanaka Kikinzoku Kogyo K.K.) was purchased to obtain a water dispersion 8. The gold particles in the water dispersion had a volume average particle diameter of 10 nm (measured with a transmission electron microscope made by Hitachi High-Technologies Corporation).

[Preparation of Ink]

The components described in Table 1 (prepared to give a total of 100 mass %) each were mixed and the mixture was subjected to pressure filtration through a membrane filter having a pore size of 2.5 μm so as to obtain each of the inks. In Table 1, the content of a water dispersion represents a solid content of the organic colorant or metal particles in the ink. A direct black 19 (DB19), a direct black 168 (DB 168), or a food black 1 (FB1) was used as the black color dye. Acetylenol EH (made by Kawaken Fine Chemicals Co., Ltd.) was used as the surfactant. In any of the inks, the average particle diameter of the organic colorant and the metal particles remained almost unchanged from the average particle diameter in the water dispersion.

Each of the inks was diluted 1000 times and then poured in a cell having an optical path length of 10 mm for measurement of the transmittance (with an absorption spectrophotometer UV-3600 (made by Shimadzu Corporation)). The inks 1 to 15, 22 and 23 had a transmittance of 65% or less in the whole wavelength region of 450 to 650 nm. The inks 16 to 21, 24 and 25 had a wavelength region with a transmittance more than 65% in the wavelength region of 450 to 650 nm.

TABLE 1
Preparation conditions of ink

| | Water dispersion | | Black color dye | | | | Ion- |
|---|---|---|---|---|---|---|---|
| | | Content | | Content | Glycerol | Acetylenol | exchanged |
| Ink No. | Type | (mass %) | Type | (mass %) | (mass %) | (mass %) | water |
| Ink 1 | Water dispersion 1 | 3 | DB168 | 3 | 8 | 1 | Balance |
| Ink 2 | Water dispersion 2 | 3 | FB1 | 3 | 8 | 1 | Balance |
| Ink 3 | Water dispersion 2 | 3 | FB1 | 1 | 8 | 1 | Balance |
| Ink 4 | Water dispersion 2 | 3 | DB19 | 3 | 8 | 1 | Balance |
| Ink 5 | Water dispersion 2 | 3 | DB19 | 1 | 8 | 1 | Balance |
| Ink 6 | Water dispersion 2 | 3 | DB168 | 3 | 8 | 1 | Balance |
| Ink 7 | Water dispersion 2 | 3 | DB168 | 1 | 8 | 1 | Balance |
| Ink 8 | Water dispersion 3 | 3 | DB168 | 3 | 8 | 1 | Balance |
| Ink 9 | Water dispersion 4 | 3 | DB168 | 3 | 8 | 1 | Balance |
| Ink 10 | Water dispersion 5 | 3 | DB19 | 3 | 8 | 1 | Balance |
| Ink 11 | Water dispersion 5 | 3 | DB19 | 1 | 8 | 1 | Balance |
| Ink 12 | Water dispersion 5 | 3 | DB168 | 3 | 8 | 1 | Balance |
| Ink 13 | Water dispersion 5 | 3 | DB168 | 1 | 8 | 1 | Balance |
| Ink 14 | Water dispersion 6 | 3 | DB19 | 3 | 8 | 1 | Balance |
| Ink 15 | Water dispersion 6 | 3 | DB19 | 1 | 8 | 1 | Balance |
| Ink 16 | Water dispersion 1 | 3 | — | 0 | 8 | 1 | Balance |
| Ink 17 | Water dispersion 2 | 3 | — | 0 | 8 | 1 | Balance |
| Ink 18 | Water dispersion 3 | 3 | — | 0 | 8 | 1 | Balance |
| Ink 19 | Water dispersion 4 | 3 | — | 0 | 8 | 1 | Balance |
| Ink 20 | Water dispersion 5 | 3 | — | 0 | 8 | 1 | Balance |
| Ink 21 | Water dispersion 6 | 3 | — | 0 | 8 | 1 | Balance |
| Ink 22 | Water dispersion 7 | 5 | DB168 | 3 | 10 | 1 | Balance |
| Ink 23 | Water dispersion 8 | 5 | DB168 | 3 | 10 | 1 | Balance |
| Ink 24 | Water dispersion 7 | 5 | — | 0 | 10 | 1 | Balance |
| Ink 25 | Water dispersion 8 | 5 | — | 0 | 10 | 1 | Balance |

[Evaluation]

An ink cartridge was filled with each of the inks and mounted on an inkjet recording apparatus. An image of 1 cm by 1 cm (solid image) was recorded on a recording medium. An F930 (recording head: 6 discharge port arrays each having 512 nozzles, ink quantity: 4.0 pL (fixed quantity), resolution: maximum 1200 dpi (horizontal) by 1200 dpi (vertical)) made by Canon was used as the inkjet recording apparatus. A photographic paper for inkjetting, i.e. Canon professional high-gloss photo paper PR-201 (made by Canon), was used as the recording medium.

The color tone of diffused light of the obtained image was measured. In the measurement, the a* and b* values in CIE color system of the obtained image were measured with the specular component excluded (SCE) mode of a spectrophotometer CM-2600d (made by Konica Minolta, Inc.). Further, the visual observation of the obtained image was performed. The results are described in Table 2.

TABLE 2
Evaluation results

| | | Color of diffused | | | Was a metallic |
|---|---|---|---|---|---|
| Example | | light | | Result of visual | texture sufficiently |
| No. | Ink No. | a* | b* | observation | given in an image? |
| Example 1 | Ink 1 | −0.7 | 15.4 | Gold color | OK |
| Example 2 | Ink 2 | −1.4 | 15.0 | Gold color | OK |
| Example 3 | Ink 3 | 12.5 | 13.7 | Slightly reddish gold | OK |
| | | | | color | |
| Example 4 | Ink 4 | −0.9 | 6.9 | Gold color | OK |
| Example 5 | Ink 5 | 21.0 | 9.5 | Slightly reddish gold | OK |
| | | | | color | |
| Example 6 | Ink 6 | −2.3 | 13.7 | Gold color | OK |
| Example 7 | Ink 7 | 15.7 | 13.7 | Slightly reddish gold | OK |
| | | | | color | |
| Example 8 | Ink 8 | 1.8 | −0.2 | Copper color | OK |
| Example 9 | Ink 9 | 4.2 | 7.5 | Gold color | OK |
| Example 10 | Ink 10 | 4.7 | −3.2 | Red metallic color | OK |
| Example 11 | Ink 11 | 5.1 | −14.7 | Slightly bluish red | OK |
| | | | | metallic color | |
| Example 12 | Ink 12 | 15.7 | −10.2 | Red metallic color | OK |
| Example 13 | Ink 13 | 12.1 | −18.3 | Slightly bluish red | OK |
| | | | | metallic color | |
| Example 14 | Ink 14 | −2.0 | 2.6 | Blue metallic color | OK |
| Example 15 | Ink 15 | −3.7 | 9.0 | Slightly yellowish blue | OK |
| | | | | metallic color | |
| Comparative | Ink 16 | 68.6 | 12.4 | Red color with subdued | NO |
| Example 1 | | | | metallic texture | |
| Comparative | Ink 17 | 53.4 | 12.1 | Red color with subdued | NO |
| Example 2 | | | | metallic texture | |
| Comparative | Ink 18 | −4.3 | −8.1 | Blue color with subdued | NO |
| Example 3 | | | | metallic texture | |
| Comparative | Ink 19 | 85.6 | −35.9 | Red color with subdued | NO |
| Example 4 | | | | metallic texture | |
| Comparative | Ink 20 | −21.3 | −51.1 | Blue color with subdued | NO |
| Example 5 | | | | metallic texture | |
| Comparative | Ink 21 | 5.5 | 98.3 | Yellow color with | NO |
| Example 6 | | | | subdued metallic texture | |
| Example 16 | Ink 22 | −1.0 | 0.5 | Silver color | OK |
| Example 17 | Ink 23 | 6.3 | 0.9 | Gold color | OK |
| Comparative | Ink 24 | 2.5 | 18.9 | Turbid yellowish silver | NO |
| Example 7 | | | | color | |
| Comparative | Ink 25 | 22.1 | −6.9 | Turbid reddish gold | NO |
| Example 8 | | | | color | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-123263, filed Jun. 16, 2014, and Japanese Patent Application No. 2015-105908, filed May 25, 2015, which are hereby incorporated by reference herein in their entirety.

1. An aqueous ink for inkjetting comprising: organic colorant particles comprising an organic colorant giving a metallic color on a recording medium; and a black color dye.

2. The aqueous ink for inkjetting according to claim 1, wherein the organic colorant particles have a volume average particle diameter of 5 nm or more and 500 nm or less.

3. The aqueous ink for inkjetting according to claim 1, wherein the content (mass %) of the black color dye is 1 mass % or more relative to the total mass of the ink.

4. An aqueous ink for inkjetting comprising: metal particles giving a metallic color on a recording medium; and a black color dye.

5. The aqueous ink for inkjetting according to claim 4, wherein the metal particles have a volume average diameter of 3 nm or more and 130 nm or less.

6. The aqueous ink for inkjetting according to claim 4, wherein the content (mass %) of the black color dye is 1 mass % or more relative to the total mass of the ink.
